(19) United States
(12) Patent Application Publication
(10) Pub. No.: US 2022/0079178 A1
(43) Pub. Date: Mar. 17, 2022

(54) Sweetened Dairy Compositions

(71) Applicant: Firmenich SA, Satigny (CH)

(72) Inventors: Mazen Moustafa, Dubai (AE); Jean-Luc Gelin, Satigny (CH); April Wong, Singapore (SG)

(73) Assignee: Firmenich SA, Satigny (CH)

(21) Appl. No.: 17/517,848

(22) Filed: Nov. 3, 2021

Related U.S. Application Data
(63) Continuation-in-part of application No. 17/294,750, filed on May 18, 2021.
(60) Provisional application No. 62/781,842, filed on Dec. 19, 2018.

(30) Foreign Application Priority Data
Jan. 9, 2019 (EP) 19150887.8

(51) Int. Cl. A23C 9/12; A23C 9/13

(52) U.S. Cl. CPC A23C 9/1206; A23C 9/1307

(57) ABSTRACT

The disclosure relates generally to flavor-modified dairy compositions. In some embodiments, the flavor-modified dairy compositions comprise hydrolysis products of lactose (e.g., glucose and galactose), a flavor modifier (such as a terpene-based compound), or any combinations thereof. In some other aspects, the disclosure provides uses of a combination of lactase and a flavor modifier (such as a terpene-based compound) to modify the flavor of a dairy composition. In some related aspects, the disclosure provides methods of modifying the flavor of a dairy composition, wherein the methods include introducing a lactase and a flavor modifier (such as a terpene-based compound) to a dairy composition.

### CROSS-REFERENCE TO RELATED APPLICATIONS

The present application is a continuation-in-part application of U.S. patent application Ser. No. 17/294,750, filed May 18, 2021, which is the United States national stage application of PCT Application No. PCT/EP2019/085994, filed Dec. 18, 2019, which claims the benefit of priority of U.S. Provisional Application No. 62/781,842, filed Dec. 19, 2018, and European Patent Application No. 19150887.8, filed Jan. 9, 2019, all of which are hereby incorporated by reference as though set forth herein in their entireties.

### TECHNICAL FIELD

The disclosure relates generally to flavor-modified dairy compositions. In some embodiments, the flavor-modified dairy compositions comprise hydrolysis products of lactose (e.g., glucose and galactose), a flavor modifier (such as a terpene-based compound), or any combinations thereof. In some other aspects, the disclosure provides uses of a combination of lactase and a flavor modifier (such as a terpene-based compound) to modify the flavor of a dairy composition. In some related aspects, the disclosure provides methods of modifying the flavor of a dairy composition, wherein the methods include introducing a lactase and a flavor modifier (such as a terpene-based compound) to a dairy composition.

### DESCRIPTION OF RELATED ART

There is consumer demand throughout the world for sweetened dairy products. Dairy products naturally contain lactose, which imparts a mild sweetening effect. But consumers often desire products that are sweeter in taste than the sweetness provided by lactose. Thus, caloric sweeteners, such as sucrose or fructose, are often added to dairy products to enhance their sweetness. Of course, adding sweeteners to dairy products increases their caloric content and makes then less healthy as a food or beverage.

Metabolic disorders and related conditions, such as obesity, diabetes, and cardiovascular disease, are major public health concerns throughout the world. The use of caloric sweeteners is a key contributor to this trend. In many cases, no-calorie or low-calorie substitutes can be used in foods and beverages in place of sucrose or fructose. Even so, these compounds impart sweetness differently from caloric sweeteners, and a number of consumers fail to view them as suitable alternatives. Moreover, such compounds may be difficult to incorporate into certain products. In some instances, they may be used as partial replacements for caloric sweeteners, but their mere presence can cause many consumers to perceive unpleasant off-tastes including, astringency, bitterness, and metallic and licorice tastes. Thus, lower-calorie sweeteners face certain challenges to their adoption.

As noted above, dairy products generally contain lactose. Lactose is a disaccharide that includes linked glucose and galactose units. Hydrolyzing lactose to form glucose and galactose tends to increase the perceived sweetness of dairy products, as these sugars are generally perceived to be sweeter than lactose. Even so, their taste profile differs from that of sucrose and fructose. Thus, hydrolyzing lactose fails to provide an adequate sweetness to meet consumer demand.

Thus, there is a continuing need to develop sweetened dairy products that have fewer calories than sucrose- and fructose-sweetened products, but which have a taste profile similar to what consumers desire in such products.

### SUMMARY

The present disclosure provides a solution to this problem, wherein dairy products are sweetened by subjecting them to a certain degree of lactose hydrolysis and/or introducing certain lower-calorie sweeteners.

In a first aspect, the disclosure provides dairy compositions, which comprise one or more lactose hydrolysis products, a flavor modifier, or any combination thereof. In some embodiments, the lactose hydrolysis products include glucose and galactose. In some embodiments, the flavor modifier includes terpene compounds, such as steviol glycosides or glucosylated derivatives thereof. In some further embodiments, the flavor modifier comprises glucosylated derivatives of natural steviol glycosides. In some further embodiments, the flavor modifier, when present in a sufficient amount to the dairy composition, improves the temporal profile or flavor profile of the dairy composition to have a sucrose-like temporal profile or flavor profile. In some embodiments, the dairy composition further comprises sucrose, fructose, or any combination thereof. In some embodiments, the flavor modifier is present in the dairy composition at a concentration ranging from 0.001 to 0.5 percent by weight, based on the total weight of the dairy composition. In some embodiments, the dairy composition further comprises rebaudioside A. In some embodiments, the dairy composition further comprises sucralose. In some embodiments, the dairy composition comprises one or more sweetness enhancers, such as: 4-amino-5,6-dimethylthieno[2,3-d]pyrimidin-2(1H)-one hydrochloride; 3-(4-amino-1H-benzo[c][1,2,6]thiadiazin-5-yloxy-2,2-dimethyl-N-propylpropanamide-2,2-dioxide; and 3-(1H-benzo[c][1,2,6]thiadiazin-4-amine-2,2-dioxide)-5-yloxy-2,2-dimethyl-N-propylpropanamide.

In a second aspect, the disclosure provides uses of a flavor modifier to enhance the sweetness of a dairy composition comprising lactose hydrolysis products. In some embodiments, the lactose hydrolysis products include glucose and galactose. In some embodiments, the flavor modifier includes terpene compounds, such as steviol glycosides or glucosylated derivatives thereof. In some further embodiments, the flavor modifier comprises glucosylated derivatives of natural steviol glycosides. In some further embodiments, the flavor modifier, when present in a sufficient amount to the dairy composition, improves the temporal profile or flavor profile of the dairy composition to have a sucrose-like temporal profile or flavor profile. In some embodiments, the dairy composition further comprises sucrose, fructose, or any combination thereof. In some embodiments, the flavor modifier is present in the dairy composition at a concentration ranging from 0.001 to 0.5 percent by weight, based on the total weight of the dairy composition. In some embodiments, the dairy composition further comprises rebaudioside A. In some embodiments, the dairy composition further comprises sucralose. In some embodiments, the dairy composition comprises one or more sweetness enhancers, such as: 4-amino-5,6-dimethylthieno[2,3-d]pyrimidin-2(1H)-one hydrochloride; 3-(4-amino-TH-benzo[c][1,2,6]thiadiazin-5-yloxy-2,2-dimethyl-N-propylpropanamide-2,2-dioxide; and 3-(1H-benzo[c][1,2,6]thiadiazin-4-amine-2,2-dioxide)-5-yloxy-2,2-dimethyl-N-propyl-propanamide.

In a third aspect, the disclosure provides a packaged dairy product, the packaged dairy product comprising a dairy composition according to the first aspect. In some embodiments thereof, the packaged dairy product is skim milk, low fat milk, whole milk, cream, UHT milk, milk having an extended shelf life, a fermented milk product, cheese, yoghurt, butter, dairy spread, butter milk, acidified milk drink, sour cream, whey based drink, ice cream, condensed milk, dulce de leche, or a flavored milk drink.

In a fourth aspect, the disclosure provides a method for modifying the flavor of a dairy composition, the method comprising: (a) providing a dairy composition comprising lactose; (b) introducing a lactase to the dairy composition to hydrolyze at least a portion of the lactose to form a hydrolyzed dairy composition comprising lactose, glucose, and galactose; and (c) introducing a flavor modifier to the hydrolyzed dairy composition to form a flavor-modified dairy composition. In some embodiments, the flavor modifier includes terpene compounds, such as steviol glycosides or glucosylated derivatives thereof. In some further embodiments, the flavor modifier comprises glucosylated derivatives of natural steviol glycosides. In some further embodiments, the flavor modifier, is introduced in a sufficient amount to the dairy composition to improve the temporal profile or flavor profile of the dairy composition to have a sucrose-like temporal profile or flavor profile. In some embodiments, the method further comprises introducing sucrose, fructose, or any combination thereof, to the hydrolyzed dairy composition. In some embodiments, modifying the flavor comprises enhancing the sweetness. In some embodiments, the flavor modifier is introduced into the hydrolyzed dairy composition at a concentration ranging from 0.001 to 0.5 percent by weight, based on the total weight of the hydrolyzed dairy composition. In some embodiments, the method further comprises introducing rebaudioside A to the hydrolyzed dairy composition. In some embodiments, the method further comprises introducing sucralose to the hydrolyzed dairy composition.

### DETAILED DESCRIPTION

In the following description, reference is made to specific embodiments which may be practiced, which is shown by way of illustration. These embodiments are described in detail to enable those skilled in the art to practice the invention described herein, and it is to be understood that other embodiments may be utilized and that logical changes may be made without departing from the scope of the aspects presented herein. The following description of example embodiments is, therefore, not to be taken in a limited sense, and the scope of the various aspects presented herein is defined by the appended claims.

In a first aspect, the disclosure provides dairy compositions, which comprise one or more lactose hydrolysis products, a flavor modifier, or any combination thereof.

As used herein, the phrases “sugar-like characteristic,” “sugar-like taste,” “sugar-like sweet,” “sugary,” and “sugar-like” are synonymous. Sugar-like characteristics include any characteristic similar to that of sucrose and include, but are not limited to, maximal response, flavor profile, temporal profile, adaptation behavior, mouthfeel, concentration/response function, tastant and flavor and sweet taste interactions, spatial pattern selectivity, and temperature effects. These characteristics are dimensions in which the taste of sucrose is different from the tastes of sweetener compositions. Whether or not a characteristic is more sugar-like is determined by an expert sensory panel who taste compositions comprising sugar and compositions according to certain aspects presented herein, and provide their impression as to the similarities of the characteristics of those compositions, with those comprising sugar. Suitable procedures for determining whether a composition has a more sugar-like taste are well known in the art.

As used herein, the term “dairy composition” refers to any composition wherein a major constituent is milk-based. In the context of the present disclosure “a major constituent” means a constituent having a dry matter which constitutes more than 20%, or more than 30%, or more than 40%, of the total dry matter of the dairy product.

In some embodiments, the flavor modifier is present in the dairy composition at a concentration ranging from 0.001 to 0.5 weight percent, based on the total weight of the dairy composition. Alternatively, in some embodiments, the concentration of the flavor modifier ranges from 0.001 to 0.45 weight percent, based on the total weight of the dairy composition. Alternatively, in some embodiments, the concentration of the flavor modifier ranges from 0.001 to 0.4 weight percent, based on the total weight of the dairy composition. Alternatively, in some embodiments, the concentration of the flavor modifier ranges from 0.001 to 0.35 weight percent, based on the total weight of the dairy composition. Alternatively, in some embodiments, the concentration of the flavor modifier ranges from 0.001 to 0.3 weight percent, based on the total weight of the dairy composition. Alternatively, in some embodiments, the concentration of the flavor modifier ranges from 0.001 to 0.25 weight percent, based on the total weight of the dairy composition. Alternatively, in some embodiments, the concentration of the flavor modifier ranges from 0.001 to 0.2 weight percent, based on the total weight of the dairy composition. Alternatively, in some embodiments, the concentration of the flavor modifier ranges from 0.001 to 0.15 weight percent, based on the total weight of the dairy composition. Alternatively, in some embodiments, the concentration of the flavor modifier ranges from 0.001 to 0.1 weight percent, based on the total weight of the dairy composition. Alternatively, in some embodiments, the concentration of the flavor modifier ranges from 0.001 to 0.09 weight percent, based on the total weight of the dairy composition. Alternatively, in some embodiments, the concentration of the flavor modifier ranges from 0.001 to 0.08 weight percent, based on the total weight of the dairy composition. Alternatively, in some embodiments, the concentration of the flavor modifier ranges from 0.001 to 0.07 weight percent, based on the total weight of the dairy composition. Alternatively, in some embodiments, the concentration of the flavor modifier ranges from 0.001 to 0.06 weight percent, based on the total weight of the dairy composition. Alternatively, in some embodiments, the concentration of the flavor modifier ranges from 0.001 to 0.05 weight percent, based on the total weight of the dairy composition. Alternatively, in some embodiments, the concentration of the flavor modifier ranges from 0.001 to 0.04 weight percent, based on the total weight of the dairy composition. Alternatively, in some embodiments, the concentration of the flavor modifier ranges from 0.001 to 0.03 weight percent, based on the total weight of the dairy composition. Alternatively, in some embodiments, the concentration of the flavor modifier ranges from 0.001 to 0.02 weight percent, based on the total weight of the dairy composition. Alternatively, in some embodiments, the concentration of the flavor modifier ranges from 0.001 to 0.01 weight percent, based on the total weight of the dairy composition. Alternatively, in some embodiments, the concentration of the flavor modifier ranges from 0.001 to 0.009 weight percent, based on the total weight of the dairy composition. Alternatively, in some embodiments, the concentration of the flavor modifier ranges from 0.001 to 0.008 weight percent, based on the total weight of the dairy composition. Alternatively, in some embodiments, the concentration of the flavor modifier ranges from 0.001 to 0.007 weight percent, based on the total weight of the dairy composition. Alternatively, in some embodiments, the concentration of the flavor modifier ranges from 0.001 to 0.006 weight percent, based on the total weight of the dairy composition. Alternatively, in some embodiments, the concentration of the flavor modifier ranges from 0.001 to 0.005 weight percent, based on the total weight of the dairy composition. Alternatively, in some embodiments, the concentration of the flavor modifier ranges from 0.001 to 0.004 weight percent, based on the total weight of the dairy composition. Alternatively, in some embodiments, the concentration of the flavor modifier ranges from 0.001 to 0.003 weight percent, based on the total weight of the dairy composition. Alternatively, in some embodiments, the concentration of the flavor modifier ranges from 0.001 to 0.002 weight percent, based on the total weight of the dairy composition.

In some embodiments, the concentration of the flavor modifier ranges from 0.002 to 0.5 weight percent, based on the total weight of the dairy composition. Alternatively, in some embodiments, the concentration of the flavor modifier ranges from 0.003 to 0.5 weight percent, based on the total weight of the dairy composition. Alternatively, in some embodiments, the concentration of the flavor modifier ranges from 0.004 to 0.5 weight percent, based on the total weight of the dairy composition. Alternatively, in some embodiments, the concentration of the flavor modifier ranges from 0.005 to 0.5 weight percent, based on the total weight of the dairy composition. Alternatively, in some embodiments, the concentration of the flavor modifier ranges from 0.006 to 0.5 weight percent, based on the total weight of the dairy composition. Alternatively, in some embodiments, the concentration of the flavor modifier ranges from 0.007 to 0.5 weight percent, based on the total weight of the dairy composition. Alternatively, in some embodiments, the concentration of the flavor modifier ranges from 0.008 to 0.5 weight percent, based on the total weight of the dairy composition. Alternatively, in some embodiments, the concentration of the flavor modifier ranges from 0.009 to 0.5 weight percent, based on the total weight of the dairy composition. Alternatively, in some embodiments, the concentration of the flavor modifier ranges from 0.01 to 0.5 weight percent, based on the total weight of the dairy composition. Alternatively, in some embodiments, the concentration of the flavor modifier ranges from 0.02 to 0.5 weight percent, based on the total weight of the dairy composition. Alternatively, in some embodiments, the concentration of the flavor modifier ranges from 0.03 to 0.5 weight percent, based on the total weight of the dairy composition. Alternatively, in some embodiments, the concentration of the flavor modifier ranges from 0.04 to 0.5 weight percent, based on the total weight of the dairy composition. Alternatively, in some embodiments, the concentration of the flavor modifier ranges from 0.05 to 0.5 weight percent, based on the total weight of the dairy composition. Alternatively, in some embodiments, the concentration of the flavor modifier ranges from 0.06 to 0.5 weight percent, based on the total weight of the dairy composition. Alternatively, in some embodiments, the concentration of the flavor modifier ranges from 0.07 to 0.5 weight percent, based on the total weight of the dairy composition. Alternatively, in some embodiments, the concentration of the flavor modifier ranges from 0.09 to 0.5 weight percent, based on the total weight of the dairy composition. Alternatively, in some embodiments, the concentration of the flavor modifier ranges from 0.09 to 0.5 weight percent, based on the total weight of the dairy composition. Alternatively, in some embodiments, the concentration of the flavor modifier ranges from 0.1 to 0.5 weight percent, based on the total weight of the dairy composition. Alternatively, in some embodiments, the concentration of the flavor modifier ranges from 0.15 to 0.5 weight percent, based on the total weight of the dairy composition. Alternatively, in some embodiments, the concentration of the flavor modifier ranges from 0.2 to 0.5 weight percent, based on the total weight of the dairy composition. Alternatively, in some embodiments, the concentration of the flavor modifier ranges from 0.25 to 0.5 weight percent, based on the total weight of the dairy composition. Alternatively, in some embodiments, the concentration of the flavor modifier ranges from 0.3 to 0.5 weight percent, based on the total weight of the dairy composition. Alternatively, in some embodiments, the concentration of the flavor modifier ranges from 0.35 to 0.5 weight percent, based on the total weight of the dairy composition. Alternatively, in some embodiments, the concentration of the flavor modifier ranges from 0.4 to 0.5 weight percent, based on the total weight of the dairy composition. Alternatively, in some embodiments, the concentration of the flavor modifier ranges from 0.45 to 0.5 weight percent, based on the total weight of the dairy composition.

In some embodiments, the concentration of the flavor modifier is 0.001 weight percent, or 0.002 weight percent, or 0.003 weight percent, or, 0.004 weight percent, or 0.005 weight percent, or 0.006 weight percent, or 0.007 weight percent, or 0.008 weight percent, or 0.009 weight percent, or 0.01 weight percent, or 0.02 weight percent, or 0.03 weight percent, or 0.04 weight percent, or 0.05 weight percent, or 0.06 weight percent, or 0.07 weight percent, or 0.08 weight percent, or 0.09 weight percent, or 0.1 weight percent, or 0.15 weight percent, or 0.2 weight percent, or 0.25 weight percent, or 0.3 weight percent, or 0.35 weight percent, or 0.4 weight percent, or 0.45 weight percent, or 0.5 weight percent, based on the total weight of the dairy composition.

In some embodiments, the composition further comprises lactose hydrolysis products, such as galactose and glucose. In some embodiments, the lactose hydrolysis products are derived from the hydrolysis of at least a portion of the lactose, for example, by a lactase. Thus, in some embodiments, the dairy composition comprises lactose, glucose, and galactose.

In some embodiments, the combination of lactose hydrolysis products and flavor modifiers permit a reduction in caloric sweeteners, such as sucrose and fructose, required to impart a comparable level of sweetness in the dairy product sweetened only with caloric sweeteners.

In some embodiments, the dairy composition comprises one or more sweeteners, such as sucrose, fructose, or combinations thereof. Other suitable sweeteners include allulose, sugar alcohols, rebaudioside A, other steviol glycosides, sucralose, acesulfame K, aspartame, mogrosides, cyclamate, saccharin, and any combinations thereof.

In some embodiments, the dairy composition comprises sucrose. In some such embodiments, the dairy composition comprises sucrose in a concentration ranging from 0.5 to 14° Bx, or from 0.5 to 10° Bx, or from 0.5 to 8° Bx, or from 0.5 to 5° Bx.

In some other embodiments, the dairy compositions comprise sweetness enhancers, such as: 4-amino-5,6-dimethylthieno[2,3-d]pyrimidin-2(1H)-one hydrochloride; 3-(4-amino-1H-benzo[c][1,2,6]thiadiazin-5-yloxy-2,2-dimethyl-N-propylpropanamide-2,2-dioxide; and 3-(1H-benzo[c][1,2,6]thiadiazin-4-amine-2,2-dioxide)-5-yloxy-2,2-dimethyl-N-propyl-propanamide.

In some embodiments, the dairy compositions comprise umami or kokumi enhancers, such as: (E)-3-(3,4-dimethoxyphenyl)-N-(4-methoxyphenethyl) acrylamide. In some embodiments, the dairy compositions comprise one or more bitter blockers.

In a second aspect, the disclosure provides uses of a flavor modifier to enhance the sweetness of a dairy composition comprising lactose hydrolysis products. The flavor modifier can be used in any suitable amount to enhance sweetness. For example, in some embodiments, the flavor modifier enhances the sweetness of the dairy composition by a sweetness ranging from 1° Bx to 10° Bx. Note that, in this context, ° Bx is a unit that refers to the amount of sweetness enhancement equivalent to introducing 1 gram of sucrose to 100 grams of the composition. Thus, a sweetness enhancement of 1° Bx refers to a sweetness equivalent to the addition of 1 gram or sucrose to 100 grams of the dairy composition.

In some embodiments, the flavor modifier is present in the dairy composition at a concentration ranging from 0.001 to 0.5 weight percent, based on the total weight of the dairy composition. Alternatively, in some embodiments, the concentration of the flavor modifier ranges from 0.001 to 0.45 weight percent, based on the total weight of the dairy composition. Alternatively, in some embodiments, the concentration of the flavor modifier ranges from 0.001 to 0.4 weight percent, based on the total weight of the dairy composition. Alternatively, in some embodiments, the concentration of the flavor modifier ranges from 0.001 to 0.35 weight percent, based on the total weight of the dairy composition. Alternatively, in some embodiments, the concentration of the flavor modifier ranges from 0.001 to 0.3 weight percent, based on the total weight of the dairy composition. Alternatively, in some embodiments, the concentration of the flavor modifier ranges from 0.001 to 0.25 weight percent, based on the total weight of the dairy composition. Alternatively, in some embodiments, the concentration of the flavor modifier ranges from 0.001 to 0.2 weight percent, based on the total weight of the dairy composition. Alternatively, in some embodiments, the concentration of the flavor modifier ranges from 0.001 to 0.15 weight percent, based on the total weight of the dairy composition. Alternatively, in some embodiments, the concentration of the flavor modifier ranges from 0.001 to 0.1 weight percent, based on the total weight of the dairy composition. Alternatively, in some embodiments, the concentration of the flavor modifier ranges from 0.001 to 0.09 weight percent, based on the total weight of the dairy composition. Alternatively, in some embodiments, the concentration of the flavor modifier ranges from 0.001 to 0.08 weight percent, based on the total weight of the dairy composition. Alternatively, in some embodiments, the concentration of the flavor modifier ranges from 0.001 to 0.07 weight percent, based on the total weight of the dairy composition. Alternatively, in some embodiments, the concentration of the flavor modifier ranges from 0.001 to 0.06 weight percent, based on the total weight of the dairy composition. Alternatively, in some embodiments, the concentration of the flavor modifier ranges from 0.001 to 0.05 weight percent, based on the total weight of the dairy composition. Alternatively, in some embodiments, the concentration of the flavor modifier ranges from 0.001 to 0.04 weight percent, based on the total weight of the dairy composition. Alternatively, in some embodiments, the concentration of the flavor modifier ranges from 0.001 to 0.03 weight percent, based on the total weight of the dairy composition. Alternatively, in some embodiments, the concentration of the flavor modifier ranges from 0.001 to 0.02 weight percent, based on the total weight of the dairy composition. Alternatively, in some embodiments, the concentration of the flavor modifier ranges from 0.001 to 0.01 weight percent, based on the total weight of the dairy composition. Alternatively, in some embodiments, the concentration of the flavor modifier ranges from 0.001 to 0.009 weight percent, based on the total weight of the dairy composition. Alternatively, in some embodiments, the concentration of the flavor modifier ranges from 0.001 to 0.008 weight percent, based on the total weight of the dairy composition. Alternatively, in some embodiments, the concentration of the flavor modifier ranges from 0.001 to 0.007 weight percent, based on the total weight of the dairy composition. Alternatively, in some embodiments, the concentration of the flavor modifier ranges from 0.001 to 0.006 weight percent, based on the total weight of the dairy composition. Alternatively, in some embodiments, the concentration of the flavor modifier ranges from 0.001 to 0.005 weight percent, based on the total weight of the dairy composition. Alternatively, in some embodiments, the concentration of the flavor modifier ranges from 0.001 to 0.004 weight percent, based on the total weight of the dairy composition. Alternatively, in some embodiments, the concentration of the flavor modifier ranges from 0.001 to 0.003 weight percent, based on the total weight of the dairy composition. Alternatively, in some embodiments, the concentration of the flavor modifier ranges from 0.001 to 0.002 weight percent, based on the total weight of the dairy composition.

In some embodiments, the concentration of the flavor modifier ranges from 0.002 to 0.5 weight percent, based on the total weight of the dairy composition. Alternatively, in some embodiments, the concentration of the flavor modifier ranges from 0.003 to 0.5 weight percent, based on the total weight of the dairy composition. Alternatively, in some embodiments, the concentration of the flavor modifier ranges from 0.004 to 0.5 weight percent, based on the total weight of the dairy composition. Alternatively, in some embodiments, the concentration of the flavor modifier ranges from 0.005 to 0.5 weight percent, based on the total weight of the dairy composition. Alternatively, in some embodiments, the concentration of the flavor modifier ranges from 0.006 to 0.5 weight percent, based on the total weight of the dairy composition. Alternatively, in some embodiments, the concentration of the flavor modifier ranges from 0.007 to 0.5 weight percent, based on the total weight of the dairy composition. Alternatively, in some embodiments, the concentration of the flavor modifier ranges from 0.008 to 0.5 weight percent, based on the total weight of the dairy composition. Alternatively, in some embodiments, the concentration of the flavor modifier ranges from 0.009 to 0.5 weight percent, based on the total weight of the dairy composition. Alternatively, in some embodiments, the concentration of the flavor modifier ranges from 0.01 to 0.5 weight percent, based on the total weight of the dairy composition. Alternatively, in some embodiments, the concentration of the flavor modifier ranges from 0.02 to 0.5 weight percent, based on the total weight of the dairy composition. Alternatively, in some embodiments, the concentration of the flavor modifier ranges from 0.03 to 0.5 weight percent, based on the total weight of the dairy composition. Alternatively, in some embodiments, the concentration of the flavor modifier ranges from 0.04 to 0.5 weight percent, based on the total weight of the dairy composition. Alternatively, in some embodiments, the concentration of the flavor modifier ranges from 0.05 to 0.5 weight percent, based on the total weight of the dairy composition. Alternatively, in some embodiments, the concentration of the flavor modifier ranges from 0.06 to 0.5 weight percent, based on the total weight of the dairy composition. Alternatively, in some embodiments, the concentration of the flavor modifier ranges from 0.07 to 0.5 weight percent, based on the total weight of the dairy composition. Alternatively, in some embodiments, the concentration of the flavor modifier ranges from 0.09 to 0.5 weight percent, based on the total weight of the dairy composition. Alternatively, in some embodiments, the concentration of the flavor modifier ranges from 0.09 to 0.5 weight percent, based on the total weight of the dairy composition. Alternatively, in some embodiments, the concentration of the flavor modifier ranges from 0.1 to 0.5 weight percent, based on the total weight of the dairy composition. Alternatively, in some embodiments, the concentration of the flavor modifier ranges from 0.15 to 0.5 weight percent, based on the total weight of the dairy composition. Alternatively, in some embodiments, the concentration of the flavor modifier ranges from 0.2 to 0.5 weight percent, based on the total weight of the dairy composition. Alternatively, in some embodiments, the concentration of the flavor modifier ranges from 0.25 to 0.5 weight percent, based on the total weight of the dairy composition. Alternatively, in some embodiments, the concentration of the flavor modifier ranges from 0.3 to 0.5 weight percent, based on the total weight of the dairy composition. Alternatively, in some embodiments, the concentration of the flavor modifier ranges from 0.35 to 0.5 weight percent, based on the total weight of the dairy composition. Alternatively, in some embodiments, the concentration of the flavor modifier ranges from 0.4 to 0.5 weight percent, based on the total weight of the dairy composition. Alternatively, in some embodiments, the concentration of the flavor modifier ranges from 0.45 to 0.5 weight percent, based on the total weight of the dairy composition.

In some embodiments, the concentration of the flavor modifier is 0.001 weight percent, or 0.002 weight percent, or 0.003 weight percent, or, 0.004 weight percent, or 0.005 weight percent, or 0.006 weight percent, or 0.007 weight percent, or 0.008 weight percent, or 0.009 weight percent, or 0.01 weight percent, or 0.02 weight percent, or 0.03 weight percent, or 0.04 weight percent, or 0.05 weight percent, or 0.06 weight percent, or 0.07 weight percent, or 0.08 weight percent, or 0.09 weight percent, or 0.1 weight percent, or 0.15 weight percent, or 0.2 weight percent, or 0.25 weight percent, or 0.3 weight percent, or 0.35 weight percent, or 0.4 weight percent, or 0.45 weight percent, or 0.5 weight percent, based on the total weight of the dairy composition.

In some embodiments, the composition further comprises lactose hydrolysis products, such as galactose and glucose. In some embodiments, the lactose hydrolysis products are derived from the hydrolysis of at least a portion of the lactose, for example, by a lactase. Thus, in some embodiments, the dairy composition comprises lactose, glucose, and galactose.

In some embodiments, the combination of lactose hydrolysis products and flavor modifiers permit a reduction in caloric sweeteners, such as sucrose and fructose, required to impart a comparable level of sweetness in the dairy product sweetened only with caloric sweeteners.

In some embodiments, the combination of lactose hydrolysis products and flavor modifiers permit a reduction in caloric sweeteners, such as sucrose and fructose, required to impart a comparable level of sweetness in the dairy product sweetened only with caloric sweeteners.

In some embodiments, the dairy composition comprises one or more sweeteners, such as sucrose, fructose, or combinations thereof. Other suitable sweeteners include allulose, sugar alcohols, rebaudioside A, other steviol glycosides, sucralose, acesulfame K, aspartame, mogrosides, cyclamate, saccharin, and any combinations thereof.

In some embodiments, the dairy composition comprises sucrose. In some such embodiments, the dairy composition comprises sucrose in a concentration ranging from 0.5 to 14° Bx, or from 0.5 to 10° Bx, or from 0.5 to 8° Bx, or from 0.5 to 5° Bx.

In some other embodiments, the dairy compositions comprise sweetness enhancers, such as: 4-amino-5,6-dimethylthieno[2,3-d]pyrimidin-2(1H)-one hydrochloride; 3-(4-amino-1H-benzo[c][1,2,6]thiadiazin-5-yloxy-2,2-dimethyl-N-propylpropanamide-2,2-dioxide; and 3-(1H-benzo[c][1,2,6]thiadiazin-4-amine-2,2-dioxide)-5-yloxy-2,2-dimethyl-N-propyl-propanamide.

In some embodiments, the dairy compositions comprise umami or kokumi enhancers, such as: (E)-3-(3,4-dimethoxyphenyl)-N-(4-methoxyphenethyl) acrylamide. In some embodiments, the dairy compositions comprise one or more bitter blockers.

In a fourth aspect, the disclosure provides methods for modifying the flavor of a dairy composition, the method comprising: (a) providing a dairy composition comprising lactose; (b) introducing a lactase to the dairy composition to hydrolyze at least a portion of the lactose to form a hydrolyzed dairy composition comprising lactose, glucose, and galactose; and (c) introducing a flavor modifier to the hydrolyzed dairy composition to form a flavor-modified dairy composition.

In some embodiments, the flavor modifier is introduced to the hydrolyzed dairy composition at a concentration ranging from 0.001 to 0.5 weight percent, based on the total weight of the hydrolyzed dairy composition. Alternatively, in some embodiments, the concentration of the flavor modifier ranges from 0.001 to 0.45 weight percent, based on the total weight of the hydrolyzed dairy composition. Alternatively, in some embodiments, the concentration of the flavor modifier ranges from 0.001 to 0.4 weight percent, based on the total weight of the hydrolyzed dairy composition. Alternatively, in some embodiments, the concentration of the flavor modifier ranges from 0.001 to 0.35 weight percent, based on the total weight of the hydrolyzed dairy composition. Alternatively, in some embodiments, the concentration of the flavor modifier ranges from 0.001 to 0.3 weight percent, based on the total weight of the hydrolyzed dairy composition. Alternatively, in some embodiments, the concentration of the flavor modifier ranges from 0.001 to 0.25 weight percent, based on the total weight of the hydrolyzed dairy composition. Alternatively, in some embodiments, the concentration of the flavor modifier ranges from 0.001 to 0.2 weight percent, based on the total weight of the hydrolyzed dairy composition. Alternatively, in some embodiments, the concentration of the flavor modifier ranges from 0.001 to 0.15 weight percent, based on the total weight of the hydrolyzed dairy composition. Alternatively, in some embodiments, the concentration of the flavor modifier ranges from 0.001 to 0.1 weight percent, based on the total weight of the hydrolyzed dairy composition. Alternatively, in some embodiments, the concentration of the flavor modifier ranges from 0.001 to 0.09 weight percent, based on the total weight of the hydrolyzed dairy composition. Alternatively, in some embodiments, the concentration of the flavor modifier ranges from 0.001 to 0.08 weight percent, based on the total weight of the hydrolyzed dairy composition. Alternatively, in some embodiments, the concentration of the flavor modifier ranges from 0.001 to 0.07 weight percent, based on the total weight of the hydrolyzed dairy composition. Alternatively, in some embodiments, the concentration of the flavor modifier ranges from 0.001 to 0.06 weight percent, based on the total weight of the hydrolyzed dairy composition. Alternatively, in some embodiments, the concentration of the flavor modifier ranges from 0.001 to 0.05 weight percent, based on the total weight of the hydrolyzed dairy composition. Alternatively, in some embodiments, the concentration of the flavor modifier ranges from 0.001 to 0.04 weight percent, based on the total weight of the hydrolyzed dairy composition. Alternatively, in some embodiments, the concentration of the flavor modifier ranges from 0.001 to 0.03 weight percent, based on the total weight of the hydrolyzed dairy composition. Alternatively, in some embodiments, the concentration of the flavor modifier ranges from 0.001 to 0.02 weight percent, based on the total weight of the hydrolyzed dairy composition. Alternatively, in some embodiments, the concentration of the flavor modifier ranges from 0.001 to 0.01 weight percent, based on the total weight of the hydrolyzed dairy composition. Alternatively, in some embodiments, the concentration of the flavor modifier ranges from 0.001 to 0.009 weight percent, based on the total weight of the hydrolyzed dairy composition. Alternatively, in some embodiments, the concentration of the flavor modifier ranges from 0.001 to 0.008 weight percent, based on the total weight of the hydrolyzed dairy composition. Alternatively, in some embodiments, the concentration of the flavor modifier ranges from 0.001 to 0.007 weight percent, based on the total weight of the hydrolyzed dairy composition. Alternatively, in some embodiments, the concentration of the flavor modifier ranges from 0.001 to 0.006 weight percent, based on the total weight of the hydrolyzed dairy composition. Alternatively, in some embodiments, the concentration of the flavor modifier ranges from 0.001 to 0.005 weight percent, based on the total weight of the hydrolyzed dairy composition. Alternatively, in some embodiments, the concentration of the flavor modifier ranges from 0.001 to 0.004 weight percent, based on the total weight of the hydrolyzed dairy composition. Alternatively, in some embodiments, the concentration of the flavor modifier ranges from 0.001 to 0.003 weight percent, based on the total weight of the hydrolyzed dairy composition. Alternatively, in some embodiments, the concentration of the flavor modifier ranges from 0.001 to 0.002 weight percent, based on the total weight of the hydrolyzed dairy composition.

In some embodiments, the concentration of the flavor modifier ranges from 0.002 to 0.5 weight percent, based on the total weight of the hydrolyzed dairy composition. Alternatively, in some embodiments, the concentration of the flavor modifier ranges from 0.003 to 0.5 weight percent, based on the total weight of the hydrolyzed dairy composition. Alternatively, in some embodiments, the concentration of the flavor modifier ranges from 0.004 to 0.5 weight percent, based on the total weight of the hydrolyzed dairy composition. Alternatively, in some embodiments, the concentration of the flavor modifier ranges from 0.005 to 0.5 weight percent, based on the total weight of the hydrolyzed dairy composition. Alternatively, in some embodiments, the concentration of the flavor modifier ranges from 0.006 to 0.5 weight percent, based on the total weight of the hydrolyzed dairy composition. Alternatively, in some embodiments, the concentration of the flavor modifier ranges from 0.007 to 0.5 weight percent, based on the total weight of the hydrolyzed dairy composition. Alternatively, in some embodiments, the concentration of the flavor modifier ranges from 0.008 to 0.5 weight percent, based on the total weight of the hydrolyzed dairy composition. Alternatively, in some embodiments, the concentration of the flavor modifier ranges from 0.009 to 0.5 weight percent, based on the total weight of the hydrolyzed dairy composition. Alternatively, in some embodiments, the concentration of the flavor modifier ranges from 0.01 to 0.5 weight percent, based on the total weight of the hydrolyzed dairy composition. Alternatively, in some embodiments, the concentration of the flavor modifier ranges from 0.02 to 0.5 weight percent, based on the total weight of the hydrolyzed dairy composition. Alternatively, in some embodiments, the concentration of the flavor modifier ranges from 0.03 to 0.5 weight percent, based on the total weight of the hydrolyzed dairy composition. Alternatively, in some embodiments, the concentration of the flavor modifier ranges from 0.04 to 0.5 weight percent, based on the total weight of the hydrolyzed dairy composition. Alternatively, in some embodiments, the concentration of the flavor modifier ranges from 0.05 to 0.5 weight percent, based on the total weight of the hydrolyzed dairy composition. Alternatively, in some embodiments, the concentration of the flavor modifier ranges from 0.06 to 0.5 weight percent, based on the total weight of the hydrolyzed dairy composition. Alternatively, in some embodiments, the concentration of the flavor modifier ranges from 0.07 to 0.5 weight percent, based on the total weight of the hydrolyzed dairy composition. Alternatively, in some embodiments, the concentration of the flavor modifier ranges from 0.09 to 0.5 weight percent, based on the total weight of the hydrolyzed dairy composition. Alternatively, in some embodiments, the concentration of the flavor modifier ranges from 0.09 to 0.5 weight percent, based on the total weight of the hydrolyzed dairy composition. Alternatively, in some embodiments, the concentration of the flavor modifier ranges from 0.1 to 0.5 weight percent, based on the total weight of the hydrolyzed dairy composition. Alternatively, in some embodiments, the concentration of the flavor modifier ranges from 0.15 to 0.5 weight percent, based on the total weight of the hydrolyzed dairy composition. Alternatively, in some embodiments, the concentration of the flavor modifier ranges from 0.2 to 0.5 weight percent, based on the total weight of the hydrolyzed dairy composition. Alternatively, in some embodiments, the concentration of the flavor modifier ranges from 0.25 to 0.5 weight percent, based on the total weight of the hydrolyzed dairy composition. Alternatively, in some embodiments, the concentration of the flavor modifier ranges from 0.3 to 0.5 weight percent, based on the total weight of the hydrolyzed dairy composition. Alternatively, in some embodiments, the concentration of the flavor modifier ranges from 0.35 to 0.5 weight percent, based on the total weight of the hydrolyzed dairy composition. Alternatively, in some embodiments, the concentration of the flavor modifier ranges from 0.4 to 0.5 weight percent, based on the total weight of the hydrolyzed dairy composition. Alternatively, in some embodiments, the concentration of the flavor modifier ranges from 0.45 to 0.5 weight percent, based on the total weight of the hydrolyzed dairy composition.

In some embodiments, the concentration of the flavor modifier is 0.001 weight percent, or 0.002 weight percent, or 0.003 weight percent, or, 0.004 weight percent, or 0.005 weight percent, or 0.006 weight percent, or 0.007 weight percent, or 0.008 weight percent, or 0.009 weight percent, or 0.01 weight percent, or 0.02 weight percent, or 0.03 weight percent, or 0.04 weight percent, or 0.05 weight percent, or 0.06 weight percent, or 0.07 weight percent, or 0.08 weight percent, or 0.09 weight percent, or 0.1 weight percent, or 0.15 weight percent, or 0.2 weight percent, or 0.25 weight percent, or 0.3 weight percent, or 0.35 weight percent, or 0.4 weight percent, or 0.45 weight percent, or 0.5 weight percent, based on the total weight of the hydrolyzed dairy composition.

In some embodiments, the hydrolyzed dairy composition further comprises lactose hydrolysis products, such as galactose and glucose. In some embodiments, the lactose hydrolysis products are derived from the hydrolysis of at least a portion of the lactose, for example, by a lactase. Thus, in some embodiments, the hydrolyzed dairy composition comprises lactose, glucose, and galactose.

In some embodiments, the combination of lactose hydrolysis products and flavor modifiers permit a reduction in caloric sweeteners, such as sucrose and fructose, required to impart a comparable level of sweetness in the dairy product sweetened only with caloric sweeteners.

In some embodiments, the combination of lactose hydrolysis products and flavor modifiers permit a reduction in caloric sweeteners, such as sucrose and fructose, required to impart a comparable level of sweetness in the dairy product sweetened only with caloric sweeteners.

In some embodiments, the hydrolyzed dairy composition comprises one or more sweeteners, such as sucrose, fructose, or combinations thereof. Other suitable sweeteners include allulose, sugar alcohols, rebaudioside A, other steviol glycosides, sucralose, acesulfame K, aspartame, mogrosides, cyclamate, saccharin, and any combinations thereof.

In some embodiments, the hydrolyzed dairy composition comprises sucrose. In some such embodiments, the hydrolyzed dairy composition comprises sucrose in a concentration ranging from 0.5 to 14° Bx, or from 0.5 to 10° Bx, or from 0.5 to 8° Bx, or from 0.5 to 5° Bx.

In some other embodiments, the hydrolyzed dairy compositions comprise sweetness enhancers, such as: 4-amino-5,6-dimethylthieno[2,3-d]pyrimidin-2(1H)-one hydrochloride; 3-(4-amino-1H-benzo[c][1,2,6]thiadiazin-5-yloxy-2,2-dimethyl-N-propylpropanamide-2,2-dioxide; and 3-(1H-benzo[c][1,2,6]thiadiazin-4-amine-2,2-dioxide)-5-yloxy-2,2-dimethyl-N-propyl-propanamide.

In some embodiments, the hydrolyzed dairy compositions comprise umami or kokumi enhancers, such as: (E)-3-(3,4-dimethoxyphenyl)-N-(4-methoxyphenethyl) acrylamide. In some embodiments, the hydrolyzed dairy compositions comprise one or more bitter blockers.

As used herein, the term “flavor modifier” refers to a compound that modifies the perception of a flavor (such as taste of sweet, sour, bitter, salt, umami, kokumi, or any combination thereof) in a human. In some embodiments thereof, the flavor modifier is a sweetness enhancer. As used herein, “sweetness enhancer” refers to any compound that enhances or intensifies the perception of sweet taste in a human. The term “sweetness enhancer” is synonymous to the terms “sweet taste potentiator,” “sweetness potentiator,” and “sweetness intensifier.” As used herein, the phrase “high intensity sweetener” means any sweetener that, in raw, extracted, purified, or any other from, singularly or in combination thereof, has a sweetness potency greater than that of sucrose (common table sugar) and has comparatively fewer calories than a sweetness-equivalent amount of sucrose. As used herein, the term “sweetener” includes any and all artificial and natural sweeteners, including sugar alcohols (or polyols), sugar sweeteners (or carbohydrates), and the like.

The compositions, uses, and methods disclosed herein employ flavor modifiers. In some embodiments thereof, the flavor modifiers are sweetness enhancers. In some embodiments, the flavor modifiers are terpene compounds. In some further such embodiments, the flavor modifiers are glucosylated terpene compounds, such as glucosylated diterpene compounds. In some further such embodiments, the flavor modifiers are steviol glycosides, i.e., natural steviol glycosides. In some other such embodiments, the flavor modifiers are glucosylated steviol glycosides (GSGs), which are natural steviol glycosides that are further functionalized to add one or more additional glucose units to the base steviol glycoside molecule, e.g., via enzymatic glucosylation.

Examples of such GSGs suitable for use in the compositions, uses, and methods described herein include, but are not limited to, the GSGs disclosed in U.S. Pat. No. 9,107,436, whose disclosure is hereby incorporated by reference.

In some embodiments, the flavor modifier comprises one or more glucosylated steviol glycosides (GSGs) and rebaudioside A.

The compositions, uses, and methods disclosed herein can include one or more additional sweeteners that are used in combination or as a component of the flavor modifier. Any suitable such sweeteners can be used. Non-limiting examples include abiziasaponin, abrusosides, in particular abrusoside A, abrusoside B, abrusoside C, abrusoside D, acesulfame potassium, advantame, albiziasaponin, alitame, aspartame, superaspartame, bayunosides, in particular bayunoside 1, bayunoside 2, brazzein, bryoside, bryonoside, bryonodulcoside, carnosifloside, carrelame, curculin, cyanin, chlorogenic acid, cyclamates and its salts, cyclocaryoside I, dihydroquercetin-3-acetate, dihydroflavenol, dulcoside, gaudichaudioside, glycyrrhizin, glycyrrhetin acid, gypenoside, hematoxylin, isomogrosides, in particular iso-mogroside V, lugduname, magap, mabinlins, micraculin, mogrosides (lo han guo), in particular mogroside IV and mogroside V, monatin and its derivatives, monellin, mukurozioside, naringin dihydrochalcone (NarDHC), neohesperidin dihydrochalcone (NHDC), neotame, osladin, pentadin, periandrin I-V, perillartine, D-phenylalanine, phlomisosides, in particular phlomisoside 1, phlomisoside 2, phlomisoside 3, phlomisoside 4, phloridzin, phyllodulcin, polpodiosides, polypodoside A, pterocaryosides, rebaudiosides, in particular rebaudioside A, rebaudioside B, rebaudioside C, rebaudioside D, rebaudioside E, rebaudioside F, rebaudioside G, rebaudioside H, rebaudioside M, rubusosides, saccharin and its salts and derivatives, scandenoside, selligueanin A, siamenosides, in particular siamenoside I, stevia, steviolbioside, stevioside and other steviol glycosides, strogines, in particular strogin 1, strogin 2, strogin 4, suavioside A, suavioside B, suavioside G, suavioside H, suavioside I, suavioside J, sucralose, sucronate, sucrooctate, talin, telosmoside A15, thaumatin, in particular thaumatin I and II, trans-anethol, trans-cinnamaldehyde, trilobatin, D-tryptophane, erythritol, galactitol, hydrogenated starch syrups including maltitol and sorbitol syrups, inositols, isomalt, lactitol, maltitol, mannitol, xylitol, arabinose, dextrin, dextrose, fructose, high fructose corn syrup, fructooligosaccharides, fructooligosaccharide syrups, galactose, galactooligosaccharides, glucose, glucose and (hydrogenated) starch syrups/hydrolysates, isomaltulose, lactose, hydrolysed lactose, maltose, mannose, rhamnose, ribose, sucrose, tagatose, trehalose, xylose, and any combinations thereof.

The compositions, uses, and methods disclosed herein can include one or more (or two or more, or three or more) sweetness enhancers that are used in combination or as a component of the flavor modifier. Any suitable such sweetness enhancers can be used. Some non-limiting examples terpenes (such as sesquiterpenes, diterpenes, and triterpenes), flavonoids, amino acids, proteins, polyols, other known natural sweeteners (such as cinnamaldehydes, selligueains and hematoxylins), secodammarane glycosides, and analogues thereof. Exemplary sweetness enhancers include steviol glycoside such as stevioside, steviolbioside, rebaudioside A, rebaudioside B, rebaudioside C, rebaudioside D, rebaudioside E, rebaudioside F, dulcoside A, rubusoside; hemandulcin; pine rosin diterpenoid; mukurozioside; baiyunosdie; phlomisoside, such as phlomisoside I and phlomisodie II; glycyrrhizic acid; periandrins, such as periandrin I, periandrin II, periandrin III, and periandrin IV; osladin; polypodosides, such as polypodoside A and polypodoside B; mogrosides, such as mogroside IV and mogroside V; abrusoside A and abrusosdie B; cyclocariosdies, such as cyclocarioside A and cyclocarioside B; pterocaryoside A and pterocaryoside B; flavonoids, such as phyllodulcin, phloridzin, neoastilbin, and dihydroquercetin acetate; amino acids, such as glycine and monatin; proteins, such as thaumatins (thaumatin I, thaumatin II, thaumatin iii, and thaumatin IV), monellin, mabinlins (mabinlin I and mabinlin II), brazzein, miraculin, and curculin; polyols such as erythritol; cinnamaldehyde; selligueains, such as selligueain A and selligueain B; hematoxylin; and mixtures thereof. Additional exemplary sweetness enhancers include pine rosin diterpenoids; phloridizin; neoastilbin; dihydroquercetin acetate; glycine; erythritol; cinnamaldehyde; selligueain A; selligueain B; hematoxylin; rebaudioside A; rebaudioside B; rebaudioside C; rebaudioside D; rebaudioside E; dulcoside A; steviolbioside; rubusoside; stevia; stevioside; steviol 13-O-β-D-glycoside; mogroside V; Luo Han Guo; siamenoside; siamenoside I; monatin and salts thereof (monatin SS, RR, RS, SR); curculin; glycyrrhizic acid and its salts; thaumatin I; thaumatin II; thaumatin III; thaumatin IV; monellin; mabinlin I; mabinlin II; brazzein; hernandulcin; phyllodulcin; glycyphyllin; phloridzin; trilobatin; baiyunoside; osladin; polypodoside A; polypodoside B; pterocaryoside A; pterocaryoside B; mukurozioside; mukurozioside lib; phlomisoside I; phlomisoside II; periandrin I; periandrin II; periandrin III; periandrin VI; periandrin V; cyclocarioside A; cyclocarioside B; suavioside A; suavioside B; suavioside G; suavioside H; suavioside I; suavioside J; labdane glycosides; baiyunoside; gaudichaudioside A; mogroside IV; iso-mogroside; bryodulcoside; bryobioside; bryoside; bryonoside; camosifloside V; camosifioside VI; scandenoside R6; 1 1-oxomogroside V; abrusoside A; abrusoside B; abrusoside C; abrusoside D; abrusoside E; gypenoside XX; glycyrrhizin; apioglycyrrhizin; araboglycyrrhizin; pentadin; perillaldehyde; rebaudioside F; steviol; 13-[(2-O-(3-O-α-D-glucopyranosyl)-β-D-glucopyranosyl-3-O-β-D-glucopyranosyl-β-D-glucopyranosyl)oxy]kaur-16-en-18-oic acid β-D-glucopyranosyl ester; 13-[(2-O-β-D-glucopyranosyl-3-O-(4-O-α-D-glucopyranosyl)-β-D-glucopyranosyl-β-D-glucopyranosyl)oxy] kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-hydroxy-kaur-16-en-18-oic acid β-D-glucopyranosyl ester; 13-methyl-16-oxo-17-norkauran-18-oic acid β-D-glucopyranosyl ester; 13-[(2-O-β-D-glucopyranosyl-3-O-β-D-glucopyranosyl-β-D-glucopyranosyl)oxy] kaur-15-en-18-oic acid β-D-glucopyranosyl ester; 13-[(2-O-D-glucopyranosyl-3-O-D-glucopyranosyl-β-D-glucopyranosyl)oxy] kaur-15-en-18-oic acid; 13-[(2-O-β-D-glucopyranosyl-3-O-β-D-glucopyranosyl]-β-D-glucopyranosyl)oxy]-1 7-hydroxy-kaur-15-en-18-oic acid β-D-glucopyranosyl ester; 13-[(2-O-β-D-glucopyranosyl-3-O-D-glucopyranosyl-β-D-glucopyranosyl)oxy]-16-hydroxy kauran-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid; isosteviol; mogroside IA; mogroside IE; mogroside 11-A; mogroside 11-E; mogroside III; mogroside V; isomogroside V; 1 1-Oxomogroside; mogrol; 1 1-oxomogrol; 1 1-oxomogroside IA; 1-[13-hydroxykaur-16-en-18-oate] β-D-glucopyranuronic acid; 13-[(2-O-β-D-glucopyranosyl β-D-glucopyranosyl)oxy]-17-hydroxy-kaur-15-en-18-oic acid β-D-glucopyranosyl ester; 13-[(2-O-β-D-glucopyranosyl-β-D-glucopyranosyl)oxy] kaur-16-en-18-oic acid-(2-O-β-D-glucopyranosyl-β-D-glucopyranosyl)ester (rebaudioside E); 13-[(2-O-α-L-rhamnopyranosyl-3-O-β-D-glucopyranosyl-β-D-glucopyranosyl)oxy] kaur-16-en-18-oic acid-(2-O-β-D-glucopyranosyl-β-D-glucopyranosyl) ester; 13-[(2-O-β-D-glucopyranosyl-3-O-P-D-glucopyranosyl-D-glucopyranosyl)oxy]-kaur-16-en-18-oic acid-(2-O-a-L-rhamnopyranosyl-β-D-glucopyranosyl) ester; 13-[(2-O-β-D-glucopyranosyl β-D-glucopyranosyl)oxy]-17-oxo-kaur-15-en-oic acid β-D-glucopyranosl ester; 13-[(2-O-(6-O-β-D-glucopyranosyl)-β-D-glucopyranosyl-β-D-glucopyranosyl)oxy] kaur-16-en-1 8-oic acid β-D-glucopyranosyl ester; 13-[(2-O-β-D-glucopyranosyl-3-O-β-D-fructofuranosyl-β-D-glucopyranosyl)oxy] kaur-16-en-1 8-oic acid β-D-glucopyranosyl ester; 13-[(2-O-β-D-glucopyranosyl-β-D-glucopyranosyl)oxy] kaur-16-en-1 8-oic acid-(6-O-β-D-xylopyranosyl-β-D-glucopyranosyl) ester; 13-[(2-O-β-D-glucopyranosyl-β-D-glucopyranosyl)oxy] kaur-16-en-1 8-oic acid-(4-O-(2-O-α-D-glucopyranosyl)-α-D-glucopyranosyl-D-glucopyranosyl) ester; 13-[(2-O-β-D-glucopyranosyl-3-O-P-D-glucopyranosyl-β-D-glucopyranosyl)oxy]kaur-16-en-1 8-oic acid-(2-O-6-deoxy-β-D-glucopyranosyl-β-D-glucopyranosyl) ester; 13-[(2-O-β-D-glucopyranosyl-β-D-glucopyranosyl)oxy] kaur-15-en-1 8-oic acid β-D-glucopyranosyl ester; 13-[(2-O-β-D-glucopyranosyl-3-O-β-D-xylopyranosyl-β-D-glucopyranosyl)oxy] kaur-16-en-1 8-oic acid β-D-glucopyranosyl ester; 13-[(2-O-β-D-xylopyranosyl-β-D-glucopyranosyl)oxy] kaur-16-en-1 8-oic acid β-D-glucopyranosyl ester; 13-[(3-O-β-D-glucopyranosyl-β-D-glucopyranosyl)oxy] kaur-16-en-1 8-oic acid β-D-glucopyranosyl ester; 13-[(2-O-6-deoxy-β-D-glucopyranosyl-3-O-β-D-glucopyranosyl-β-D-glucopyranosyl)oxy] kaur-16-en-18-oic acid β-D-glucopyranosyl ester; 13-[(2-O-6-deoxy β-D-glucopyranosyl-β-D-glucopyranosyl)oxy] kaur-16-en-1 8-oic acid β-D-glucopyranosyl ester; and any combinations thereof. Additional non-limiting examples include rebaudioside C, rebaudioside F, rebaudioside D, 13-[(2-O-β-D-glucopyranosyl-3-O-β-D-glucopyranosyl]-β-D-glucopyranosyl)oxy]-17-hydroxy-kaur-15-en-1 8-oic acid β-D-glucopyranosyl ester, 13-[(2-O-(3-O-β-D-glucopyranosyl)-β-D-glucopyranosyl-3-O-β-D-glucopyranosyl-β-D-glucopyranosyl)oxy] kaur-16-en-1 8-oic acid β-D-glucopyranosyl ester, and rubusoside. Further, for example, the at least one sweetness enhancer is chosen from the group consisting of rebaudioside A, stevioside, rebaudioside D, rebaudioside E, mogroside V, mogroside IV, brazzein, and monatin.

The one or more additional sweetness enhancers can be employed at any suitable concentration. In some embodiments, the at least one sweetness enhancer is present in the composition at a concentration at or below the sweetness detection threshold level (for humans) of the at least one sweetness enhancer. The sweetness detection threshold level can be specific for a particular compound. In some further embodiments, the at least one sweetness enhancer is present in the composition at a concentration ranging from 0.5 ppm to 1000 ppm, or from 1 ppm to 300 ppm, or from 0.1 ppm to 75 ppm or from 500 ppm to 3,000 ppm.

As used herein, the terms “sweetness threshold,” “sweetness recognition threshold,” and “sweetness detection threshold” refer to the level at which the lowest known concentration of a certain sweet compound that is generally perceivable by a human as sweet. For example, a typical sweetness threshold level for sucrose in water is 0.5%. Further for example, the at least one sweetness enhancer to be used can be assayed in water at least 25% lower and at least 25% higher than the sucrose detection level of 0.5% in water to determine the sweetness threshold level. A person of skill in the art will be able to select the concentration of the at least one sweetness enhancer so that it may impart an enhanced sweetness to a composition comprising at least one sweetener. For example, a skilled artisan may select a concentration for the at least one sweetness enhancer so that the at least one sweetness enhancer does not impart any perceptible sweetness to a composition that does not comprise at least one sweetener. In some embodiments, the compounds listed above as sweeteners may also function as sweetness enhancers. Generally speaking, some sweeteners may also function as sweetness enhancers and vice versa.

The compositions, uses, and methods disclosed herein employ lactose hydrolysis products, namely, glucose and galactose. These hydrolysis products can be generated in any suitable way. In some embodiments, the lactose hydrolysis products are generated by introducing a lactase to hydrolyze at least a portion of the lactose present in the dairy composition to form lactose hydrolysis products. Lactases can be isolated from a wide variety of organisms, including microorganisms. Lactases are often an intracellular component of microorganisms like Kluyveromyces and Bacillus. Kluyveromyces, especially K. fragilis and K. lactis, and other fungi such as those of the genera Candida, Torula and Torulopsis, are a common source of fungal lactases, whereas B. coagulans and B circulans are well known sources for bacterial lactases.

Several lactase preparations derived from such organisms are available commercially, such as, for example, LACTOZYM (Novozymes, Denmark), HA-Lactase (Chr. Hansen, Denmark) and MAXILACT (DSM, Netherlands), each of which is produced from K. lactis. Such lactase preparations are suitable for use in the compositions, uses, and methods disclosed herein. Other commercial lactase preparations include SAPHERA (Novozymes, Denmark), GODO-YNL2 (DuPont, Wilmington, Del., US), and Lactase F100-SD (Amano). Such lactase preparations are suitable for use in the compositions, uses, and methods disclosed herein.

Other lactase preparations suitable for use in the compositions, uses, and methods disclosed herein include the lactase preparations described in PCT Publication No. WO 2009/071539.

Other lactase preparations suitable for use in the compositions, uses, and methods disclosed herein include the lactase preparations described in PCT Publication No. WO 2017/167848.

Other lactase preparations suitable for use in the compositions, uses, and methods disclosed herein include the lactase preparations described in described in PCT Publication No. WO 2017/167849.

In some embodiments, the treatment of the dairy composition with the lactase (in the compositions, uses, and methods set forth above) results in the hydrolysis of at least 70%, or at least 80%, or at least 90%, or at least 95%, or at least 98% of the lactose present in the dairy product. In some embodiments, the weight/weight ratio of lactose hydrolysis products to lactose in the composition ranges from 2:1 to 100:1, or from 3:1 to 100:1, or from 4:1 to 100:1, or from 5:1 to 100:1, or from 10:1 to 100:1, or from 20:1 to 100:1, or from 40:1 to 100:1, or from 50:1 to 100:1.

In some embodiments, the dairy composition comprises a fruit juice concentrate, for example, as a stabilizer. In some embodiments, the fruit juice concentrate is a grape juice concentrate. The fruit juice concentrate can be present in the dairy composition in any suitable amount. For example, in some embodiments, the fruit juice concentrate is present in a concentration ranging from 1 percent by weight to 15 percent by weight, or from 2 percent by weight to 12 percent by weight, or from 3 percent by weight to 10 percent by weight, or from 4 percent by weight to 8 percent by weight.

In a third aspect, the compositions set forth herein, or the compositions generated by the uses or methods set forth herein, can be incorporated into various dairy products. As used herein, the term “dairy product” refers to any food product wherein one of the major constituents is milk-based. In some aspects, the major constituent is a milk-based substrate which has been treated with an enzyme having lactase activity. In the context of the present disclosure “one of the major constituents” or “a major constituent” mean a constituent having a dry matter which constitutes more than 20%, or more than 30%, or more than 40%, of the total dry matter of the dairy product, whereas “the major constituent” means a constituent having a dry matter which constitutes more than 50%, or more than 60%, or more than 70% of the total dry matter of the dairy product. Non-limiting examples of dairy products include skim milk, low fat milk, whole milk, cream, UHT milk, milk having an extended shelf life, a fermented milk product, cheese, yoghurt, butter, dairy spread, butter milk, acidified milk drink, sour cream, whey based drink, ice cream, condensed milk, dulce de leche, and a flavored milk drink. A dairy product may be manufactured by any method known in the art.

A dairy product may additionally comprise non-milk components, e.g. vegetable components such as, e.g., vegetable oil, vegetable protein, or vegetable carbohydrates. Dairy products may also comprise further additives, such as enzymes, flavoring agents, microbial cultures such as probiotic cultures, salts, sweeteners, sugars, acids, fruit, fruit juices, or any other component known in the art as a component of, or additive to, a dairy product.

In some embodiments, the dairy product is a dairy product that is not enriched by the addition of galactooligosaccharides.

In some embodiments, the enzyme-treated milk-based substrate is not dried before being used as an ingredient in the dairy product.

In some embodiments, the dairy product is ice cream. In the present context, ice cream may be any kind of ice cream such as full fat ice cream, low fat ice cream, or ice cream based on yoghurt or other fermented milk products. Ice cream may be manufactured by any method known in the art.

In some embodiments, the dairy product is milk or condensed milk. The condensed milk may be manufactured by any method known in the art.

In some embodiments, the dairy product is UHT milk. UHT milk in the context of the present disclosure is milk which has been subjected to a sterilization procedure which is intended to kill all microorganisms, including the bacterial spores. UHT (ultra high temperature) treatment may be, e.g., heat treatment for 30 seconds at 130° C., or heat treatment for one second at 145° C.

In some embodiments, the dairy product is ESL milk. ESL milk in the context of the present invention is milk which has an extended shelf life due to microfiltration or heat treatment and which is able to stay fresh for at least 15 days, preferably for at least 20 days, on the store shelf at 2-5° C.

In some embodiments, the dairy product is selected from the group consisting of: skim milk, low fat milk, whole milk, cream, UHT milk, milk having an extended shelf life, a fermented milk product, cheese, yoghurt, butter, dairy spread, butter milk, acidified milk drink, sour cream, whey based drink, ice cream, condensed milk, dulce de leche, and a flavored milk drink.

In some aspects, the dairy product is a lactic fermented dairy product, e.g., yoghurt. The yoghurt can be any suitable kind of yoghurt, including Greek-style yoghurt.

A “fermented dairy product” in the context of the present disclosure is to be understood as any dairy product wherein any type of fermentation forms part of the production process. Examples of fermented dairy products are products like yoghurt, buttermilk, creme fraiche (sour cream), quark, and fromage frais. A fermented dairy product may be produced by any method known in the art.

“Fermentation” in the method of the present invention means the conversion of carbohydrates into alcohols or acids through the action of one or more microorganisms. Alternatively, fermentation in the method of the present invention comprises conversion of lactose to lactic acid.

In the context of the present disclosure, “microorganism” may include any bacterium, yeast, mold, or fungus being able to ferment the milk substrate.

The microorganisms used for most fermented milk products are selected from the group of bacteria generally referred to as lactic acid bacteria. As used herein, the term “lactic acid bacterium” designates a gram-positive, microaerophilic or anaerobic bacterium, which ferments sugars with the production of acids including lactic acid as the predominantly produced acid, acetic acid and propionic acid. The industrially most useful lactic acid bacteria are found within the order “Lactobacillales” which includes Lactococcus spp., Streptococcus spp., Lactobacillus spp., Leuconostoc spp., Pseudoleuconostoc spp., Pediococcus spp., Brevibacterium spp., Enterococcus spp. and Propionibacterium spp. Additionally, lactic acid producing bacteria belonging to the group of anaerobic bacteria, bifidobacteria, i.e. Bifidobacterium spp., which are frequently used as food cultures alone or in combination with lactic acid bacteria, are generally included in the group of lactic acid bacteria.

Lactic acid bacteria are normally supplied to the dairy industry either as frozen or freeze-dried cultures for bulk starter propagation or as so-called “Direct Vat Set” (DVS) cultures, intended for direct inoculation into a fermentation vessel or vat for the production of a fermented dairy product. Such cultures are in general referred to as “starter cultures” or “starters.”

Commonly used starter culture strains of lactic acid bacteria are generally divided into mesophilic organisms having optimum growth temperatures at about 30° C. and thermophilic organisms having optimum growth temperatures in the range of about 40 to about 45° C. Typical organisms belonging to the mesophilic group include Lactococcus lactis, Lactococcus lactis subsp. cremoris, Leuconostoc mesenteroides subsp. cremoris, Pseudoleuconostoc mesenteroides subsp. cremoris, Pediococcus pentosaceus, Lactococcus lactis subsp. lactis biovar. diacetylactis, Lactobacillus casei subsp. casei and Lactobacillus paracasei subsp. paracasei. Thermophilic lactic acid bacterial species include as examples Streptococcus thermophilus, Enterococcus faecium, Lactobacillus delbrueckii subsp. lactis, Lactobacillus helveticus, Lactobacillus delbrueckii subsp. bulgaricus and Lactobacillus acidophilus.

Also the anaerobic bacteria belonging to the genus Bifidobacterium including Bifidobacterium bifidum, Bifidobacterium animalis and Bifidobacterium longum are commonly used as dairy starter cultures and are generally included in the group of lactic acid bacteria. Additionally, species of Propionibacteria are used as dairy starter cultures, in particular in the manufacture of cheese. Additionally, organisms belonging to the Brevibacterium genus are commonly used as food starter cultures.

Another group of microbial starter cultures are fungal cultures, including yeast cultures and cultures of filamentous fungi, which are particularly used in the manufacture of certain types of cheese and beverage. Examples of fungi include Penicillium roqueforti, Penicillium candidum, Geotrichum candidum, Torula kefir, Saccharomyces kefir and Saccharomyces cerevisiae.

In one embodiment of the present invention, the microorganism used for fermentation of the milk-based substrate is Lactobacillus casei or a mixture of Streptococcus thermophilus and Lactobacillus delbrueckii subsp. bulgaricus.

Fermentation processes to be used in a method of the present disclosure are well known and the person of skill in the art will know how to select suitable process conditions, such as temperature, oxygen, amount and characteristics of microorganism/s, additives such as e.g. carbohydrates, flavors, minerals, enzymes, and process time. Obviously, fermentation conditions are selected so as to support the achievement of the present disclosure.

### EXAMPLES

### Example 1: Preparation and Sensory Properties of Dairy Products According to Certain Aspects Presented Herein

Table 1 below describes three sample dairy products: one comprising lactase-treated UHT milk (Test 1), another further comprising steviol glycosides having additional glucose units added to the base steviol glycoside molecules via enzymatic glucosylation (GSG) (Test 2), and another further comprising steviol glycosides having additional glucose units added to the base steviol glycoside molecules via enzymatic glucosylation and 2.5% sucrose (Test 3). Table 1 also describes a control sample dairy product comprising untreated UHT milk (CONTROL), and another control sample dairy product comprising untreated UHT milk further comprising 5% sucrose (TARGET).

The dairy products were prepared as follows: Liquid lactase GODO-YNL2 (DuPont-DK) was added to UHT milk, and the lactase/UHT milk mixture was incubated at 40° C. for 5 hours to fully hydrolyse the lactose within the UHT milk. The lactase-treated UHT milk was split into equal aliquots, and the aliquots used to prepare the Test samples and the base samples, according to the amounts disclosed in Table 1.

The sweetness of the Target and test samples were assessed and the results reported in Table 1.

Table 2 describes three sample dairy products: one comprising lactase-treated plain yoghurt and 4% sucrose (Test 1), another further comprising steviol glycosides having additional glucose units added to the base steviol glycoside molecules via enzymatic glucosylation (GSG) and 4% sucrose, wherein the lactase treatment comprised both a lactic starter (bacterial culture) and the addition of lactase (Test 2), and another further comprising steviol glycosides having additional glucose units added to the base steviol glycoside molecules via enzymatic glucosylation and 4% sucrose, wherein the lactase treatment comprised a lactic starter (bacterial culture) alone (Test 3). Table 2 also describes a control sample dairy product comprising lactase-treated plain yoghurt, wherein the lactase treatment comprised a lactic starter (bacterial culture) alone (TARGET—7% sucrose), or a control sample dairy product comprising lactase-treated plain yoghurt, wherein the lactase treatment comprised a lactic starter (bacterial culture) alone (TARGET—4% CONTROL).

As used herein, a lactic starter bacterial culture refers to a bacterial culture used to inoculate a dairy base. One example may be a freeze dried bacterial culture that may be added to milk.

The dairy products were prepared as follows: Skimmed milk powder and sucrose were mixed into pasteurized whole milk, pasteurized and allowed to cool to 40° C. Lactic starter was added to the cooled mixture, and incubated at 42° C., until the pH of the culture reached pH 4.50 to pH 4.60. The culture was then cooled The cooled culture was split into equal aliquots, and the aliquots used to prepare the Test samples and the base samples, according to the amounts disclosed in Table 2. Where required, a commercial liquid lactase preparation (Novozymes) was added to cooled culture, and incubated at 40° C. for 5 hours to fully hydrolyse the lactose within the culture.

The sweetness of the Target and test samples were assessed and the results reported in Table 3.

No significant difference was reported in the samples tested. However, differences in the sweetness, sourness, and cultured aspects were observed, wherein the lactase sample comprising GSG had similar sensory properties to the target sample.

Table 4 describes three sample dairy products: one comprising recombined milk, 2.5% sucrose and steviol glycosides having additional glucose units added to the base steviol glycoside molecules via enzymatic glucosylation (GSG) (Test 1), another comprising lactase treated recombined milk and 2.5% sucrose (Test 2), and another comprising lactase treated recombined milk 2.5% sucrose and steviol glycosides having additional glucose units added to the base steviol glycoside molecules via enzymatic glucosylation (GSG) (Test 3). Table 4 also describes a control sample dairy product comprising recombined milk, and 2.5% sucrose (CONTROL).

The dairy products were prepared as follows: Skimmed milk powder and sucrose were mixed into water. The mixture was then split into equal aliquots, and the aliquots used to prepare the Test samples and the control samples, according to the amounts disclosed in Table 4. Where required, liquid lactase (Amano) was added to the sample, and incubated at 40° C. for 5 hours to fully hydrolyse the lactose within the sample. After this time, the lactase was inactivated by pasteurization.

The sweetness of the Target and test samples were assessed and the results reported in Table 5.

Lactase treatment was found to increase the sweetness of the test samples, compared to the control. The GSG alone was found to further increase the sweetness, compared to the control sample, and the lactase treatment alone. However, the highest sweetness score was observed in the sample both treated with lactase, and further comprising GSG.

### Example 2: Preparation and Sensory Properties of Dairy Products According to Certain Aspects Presented Herein

Table 6 below describes other dairy products according to certain aspects presented herein, wherein the dairy product comprises a plain yoghurt. Sensory evaluation will be performed according to the methods described in Example 1 above.

### Example 3: Sweetened Concentrated Dairy Product

A sweetened condensed dairy product was prepared by the following steps. First, dry dairy powders (skim milk powder; whey powder; dairy based powders) were mixed in still water (40° C.) for 10 minutes. Then, sugar was added into water-based dairy preparation and mixed for 15 minutes at 40° C. Then, vegetable oil was added and mixed into the water-based dairy preparation. Then, if the run was for a test sample (as opposed to a comparative sample), lactase enzyme was added and lactose hydrolysis was run for 3-5 hours at 40° C. The hydrolysis was carried out until nearly all of the lactose was hydrolyzed to hydrolysis products. Then, the mixture was preheated to 60° C. and homogenized, followed by pasteurization in a water bath at 90° C. for 5 minutes. The pasteurization also inactivated the lactase if present in the composition. The pasteurized mixture is then cooled to below 25° C., and filled into single-use sterile bottles.

Characterization of the test sample and a control sample (no lactase addition) were tested for sweetness, water activity, and mouthcoating. Results are shown in Table 7. In comparison with full sugar target sample, the addition of both lactase enzyme and flavor (glucosylated steviol glycosides) in low sugar preparation allows to match sweetness intensity, increase “mouthcoating” while maintaining a low water activity in the same order of magnitude (range 0.830 to 0.840).

Water activity was characterized as follows. Samples at 25° C. were measured using AquaLab Pre Water Activity Analyzer and with the following method of measurement:
1. Switch on the power and main switch of the analyzer and allow instrument to warm up for 15 minutes prior to usage.
2. Select normal measuring mode and calibrate the machine using 0.760 a_{w} verification standard.
3. Load the verification standard into the sample cup, enough to cover the base of the cup but below the line.
4. Close the sample drawer and turn the knob from OPEN/LOAD to READ to start measurement.
5. Ensure water activity displayed is within +0.01 water activity of 0.760 a_{w}, if not retry the measurement with a new standard or clean the instrument.
6. Pour the sweet concentrated dairy product into a dry sample cup enough to cover the base of the cup but below the line, and ensure that the exterior of the cup rim is clean.
7. Ensure sample is within 4° C. of the instrument sample before measuring.
8. Take 3 readings for each sample and record the average water activity.

Sensory testing was performed as follows. Sweetened Concentrated Dairy Products were diluted 10% in still water at room temperature. Ten trained panelists were asked to rate the intensity of sensory attributes using a 0 to 5 structured scale (from 0 ‘not perceptible’ to 5 ‘strong intensity’). Sensory descriptors “Sweetness” and “Mouthcoating” were selected to assess taste and touch (mouthfeel) stimuli. Product presentation was blind and randomized. Data treatment was run with XLSTAT software.

### Example 4: Sweetened and Stabilized Dairy Product

A sweetened dairy product was prepared by the following steps. First, the glucosylated steviol glycosides and lactase (TasteGEM SWL, Firmenich) were added to full-fat milk and kept overnight, e.g., for 4-6 hours at a temperature of 35-40° C. (In some embodiments, reconstituted milk can alternatively be used.) In a separate container, a portion of the grape juice concentrate (and, optionally, sucrose) are dispersed into water with vigorous stirring until any undissolved material dissolves. This solution is then mixed with the preceding milk composition, and is stirred until homogeneous. During the stirring, the remaining grape juice concentrate (and any additional sucrose) are added. The resulting mixture was homogenized at a pressure of 200-250 bar. The homogenized mixture was heated to 90° C. for 15 seconds. (One may use alternate heating temperatures and times to achieve similar results. Also, if longer shelf life is desired, one can heat to around 138° C. for 3-5 seconds.) The mixture was then cooled to 3-5° C. (If long shelf life is desired, the mixture need only be cooled to below 25° C. and asceptically filled and handled at ambient temperatures. In some alternative embodiments, the product is a pasteurized product, and the glucosylated steviol glycosides with lysate (TasteGEM SWL) is added after pasteurization and the lactase hydrolysis occurs during product cold storage. The relative amounts of the ingredients were as follows: full-fat cow milk at 76 weight percent; water at 17.3 weight percent; a stabilizer at 0.4 weight percent; grape juice concentrate at 6 weight percent; a vitamin premix at 0.1 weight percent; and TasteGEM SWL at 0.2 weight percent.

TABLE 1

| | CONTROL | | BASE | | TEST 1 | | TEST 2 | | TEST 3 | | TARGET | |
|---|---|---|---|---|---|---|---|---|---|---|---|---|
| | DTD15 | 85 | DTD15 | 82 | DTD15 | 86 | DTD15 | 87 | DTD15 | 88 | DTD15 | 89 |
| | % | weight | % | weight | % | weight | % | weight | % | weight | % | weight |
| UHT milk semi- | 100 | 100 | 99.9 | 999 | | | | | | | 95 | 95 |
| skimmed (Lactel-FR ) | | | | | | | | | | | | |
| Liquid lactase GODO- | | | 0.1 | 1 | | | | | | | | |
| YNL2 (DuPont-DK) | | | | | | | | | | | | |
| Base DTD15-82 (after | | | | | 100 | 100 | 99.986 | 99.986 | 97.486 | 97.486 | | |
| hydrolyis) | | | | | | | | | | | | |
| Flavor comprising | | | | | | | 0.0139 | 0.0139 | 0.0139 | 0.0139 | | |
| GSG (GSG from | | | | | | | (0.0125% | (0.0125% | (0.0125% | (0.0125% | | |
| PureCircle USA) | | | | | | | final | final | final | final | | |
| | | | | | | | amount | amount | amount | amount | | |
| | | | | | | | of GSG) | of GSG) | of GSG) | of GSG) | | |
| Sucrose | | | | | | | | | 2.5 | 2.5 | 5 | 5 |
| TOTAL: | 100 | 100 | 100 | 1000 | 100 | 100 | 100 | 100 | 100 | 100 | 100 | 100 |
| Sweetness | No | | | | low | | medium | | high | | high | |
| assessment | | | | | | | | | | | | |

TABLE 2

| | | | | | TEST 1 | | TEST 2 | | TEST 3 | | | |
|---|---|---|---|---|---|---|---|---|---|---|---|---|
| | TARGET | | CONTROL | | Sugar 4% | | Sugar 4% | | Sugar 4% | | | |
| | Sugar 7% | | Sugar 4% | | lactase | | lactase-Flavor | | flavor | | | |
| | batch | 5 | DTD15 | 7 | DTD15 | 7.1 | DTD15 | 7.2 | DTD15 | 7.3 | DTD16 | 8.3 |
| | % | weight | % | weight | % | weight | % | weight | % | weight | % | Masse |
| Pasteurised whole milk | 86 | 430 | 89 | 445 | 88.96 | 444.8 | 88.946 | 444.73 | 88.861 | 444.31 | | |
| (Lactel - FR) | | | | | | | | | | | | |
| Instant skim milk | 4 | 20 | 4 | 20 | 4 | 20 | 4 | 20 | 4 | 20 | | |
| powder Rapidlait | | | | | | | | | | | | |
| (Migros-CH) | | | | | | | | | | | | |
| Sucrose | 7 | 35 | 4 | 20 | 4 | 20 | 4 | 20 | 4 | 20 | | |
| Indirect Lactic Starter: | 3 | 15 | 3 | 15 | 3 | 15 | 3 | 15 | 3 | 15 | | |
| Yogurt Velouté | | | | | | | | | | | | |
| (Danone-FR) | | | | | | | | | | | | |
| Liquid lactase Saphera ® | | | | | 0.04 | 0.2 | 0.04 | 0.2 | | | | |
| (Novozyme - DK) | | | | | | | | | | | | |
| Flavor comprising GSG | | | | | | | 0.0139 | 0.0695 | 0.0139 | 0.0695 | | |
| (GSG from PureCircle | | | | | | | (0.0125% | | (0.0125% | | | |
| USA) | | | | | | | final | | final | | | |
| | | | | | | | amount | | amount | | | |
| | | | | | | | of GSG) | | of GSG) | | | |
| TOTAL: | 100 | 500 | 100 | 500 | 100 | 500 | 100 | 500 | 100 | 500 | | |

TABLE 3

| | | | | TEST 2 | | |
|---|---|---|---|---|---|---|
| | | | TEST 1 | Sugar 4% | TEST 3 | |
| | TARGET | CONTROL | Sugar 4% | lactase- | Sugar 4% | |
| | Sugar 7% | Sugar 4% | lactase | Flavor | flavor | |
| trials N° : | batch 5 | Batch 7 | Batch 7.1 | Batch 7.2 | Batch 7.3 | Probability P |
| Sweetness | 3.8 A | 1.3 C | 2.4 B | 3.8 A | 2.5 B | <0.0001% *** |
| Sourness | 1.9 C | 3.0 A | 2.6 AB | 1.9 C | 2.6 B | <0.0001% *** |
| Cultured | 2.3 C | 3.2 A | 2.8 AB | 2.2 C | 2.6 BC | 0.005% * |
| Creamy | 2.8 | 2.4 | 2.7 | 3 | 2.6 | 0.3 |

ANOVA results (Probability P): significant difference between sample at 90% (!) - 95% (*) - 99 (**) and 99.9% (***) confidence
Duncan Test: No significant difference between sample sharing same letter A, B or C

TABLE 4

| | CONTROL | | Test 1 | | Test 2 | | Test 3 | | | | | |
|---|---|---|---|---|---|---|---|---|---|---|---|---|
| | DTD18 | 107 | DTD18 | 108 | DTD18 | 119 | DTD18 | 120 | | | DTD16 | 1 |
| | % | weight | % | weight | % | weight | % | weight | % | Masse | % | Masse |
| Bottled water | 87.5 | 437.5 | 87.486 | 437.43 | 87.45 | 437.25 | 87.436 | 437.18 | 100 | 500 | 100 | 500 |
| (Arkina - CH) | | | | | | | | | | | | |
| Instant skim milk | 10 | 50 | 10 | 50 | 10 | 50 | 10 | 50 | | | | |
| powder Rapidlait | | | | | | | | | | | | |
| (Migros-CH) | | | | | | | | | | | | |
| Sucrose | 2.5 | 12.5 | 2.5 | 12.5 | 2.5 | 12.5 | 2.5 | 12.5 | | | | |
| Flavor comprising | | | 0.0139 | 0.0695 | | | 0.0139 | 0.0695 | | | | |
| GSG (GSG from | | | (0.0125% | | | | (0.0125% | | | | | |
| PureCircle | | | final | | | | final | | | | | |
| USA) | | | amount | | | | amount | | | | | |
| | | | of GSG) | | | | of GSG) | | | | | |
| Dry lactase enzyme | | | | | 0.05 | 0.25 | 0.05 | 0.25 | | | | |
| F-Amano 100FD | | | | | | | | | | | | |
| (Amano - JP) | | | | | | | | | | | | |
| TOTAL: | 100 | 500 | 100 | 500 | 100 | 500 | 100 | 500 | 100 | 500 | 100 | 500 |

TABLE 5

| | Control | | | | | |
|---|---|---|---|---|---|---|
| | 2.5% sucrose | test 1 | test 2 | Test 3 | | |
| | DTD18-107 | DTD18-108 | DTD18-119 | DTD18-120 | F calc. | Proba. |
| Sweet | 2.19 D | 4.00 B | 3.25 C | 4.50 A | 19.33 | <0.0001 |
| | | | | | | *** |
| Milky | 3 | 3.13 | 2.75 | 2.8 | 0.91 | 0.4536 |
| Mouthcoating | 2 | 2.5 | 2.44 | 2.63 | 2.14 | 0.125 |
| Thick | 1.44 | 1.75 | 1.5 | 1.5 | 0.65 | 0.5927 |
| Fatty | 1.31 | 1.56 | 1.81 | 1.69 | 1.05 | 0.3906 |

TABLE 6

| | | | Example 4 | | Example 5 | | Example 6 | | Example 7 | |
|---|---|---|---|---|---|---|---|---|---|---|
| | TARGET | | Low-sugar (4%) | | Sugar free | | Sugar-free | | Sugar free | |
| | Sugar 7% | | Binary/artif | | Ternary/all nat | | ternary/artif | | ternary/hybrid | |
| | DTD18 | a | DTD18 | b | DTD18 | c | DTD18 | d | DTD18 | e |
| | % | weight | % | weight | % | weight | % | weight | % | weight |
| Pasteurised whole milk | 86 | 430 | 88.938 | 444.69 | 92.936 | 464.68 | 92.951 | 464.76 | 92.942 | 464.71 |
| (Lactel -FR) | | | | | | | | | | |
| Instant skim milk powder | 4 | 20 | 4 | 20 | 4 | 20 | 4 | 20 | 4 | 20 |
| Rapidlait (Migros-CH) | | | | | | | | | | |
| Sucrose | 7 | 35 | 4 | 20 | | | | | | |
| Indirect Lactic Starter: Yogurt | 3 | 15 | 3 | 15 | 3 | 15 | 3 | 15 | 3 | 15 |
| Velouté (Danone-FR) | | | | | | | | | | |
| Liquid lactase (Novozyme-DK) | | | 0.04 | 0.2 | 0.04 | 0.2 | 0.04 | 0.2 | 0.04 | 0.2 |
| Flavor comprising GSG (GSG | | | | | 0.0139 | 0.0695 | | | 0.0139 | 0.0695 |
| from PureCircle USA) | | | | | (0.0125 | | | | (0.0125 | |
| | | | | | % final | | | | % final | |
| | | | | | amount | | | | amount | |
| | | | | | of GSG) | | | | of GSG) | |
| Flavor comprising Sweetness | | | 0.022% | 0.11 | | | | | | |
| Ehnancer (Firmenich-CH)* | | | (0.0022% | | | | | | | |
| | | | final | | | | | | | |
| | | | amount of | | | | | | | |
| | | | ingredient) | | | | | | | |
| Flavor comprising Sweetness | | | | | | | 0.0045% | 0.0225 | | |
| Ehnancer (Firmenich-CH)** | | | | | | | (0.0009% | | | |
| | | | | | | | final | | | |
| | | | | | | | amount of | | | |
| | | | | | | | ingredient) | | | |
| Rebaudioside A 95% | | | | | 0.01 | 0.05 | | | | |
| (Purecircle-USA) | | | | | | | | | | |
| Sucralose | | | | | | | 0.0045 | 0.0225 | 0.0045 | 0.0225 |
| TOTAL: | 100 | 500 | 100 | 500 | 100 | 500 | 100 | 500 | 100 | 500 |

*3 -(4-amino-1H-benzo[c][1,2,6]thiadiazin- 5-yloxy-2,2-dimethyl-N-propylpropanamide-2,2-dioxide; 3-(1H-benzo[c][1,2,6]thiadiazin-4-amine- 2,2-dioxide)-5-yloxy-2,2-dimethyl-N-propylpropanamide
**4-Amino-5,6-dimethylthieno[2,3- d]pyrimidin-2(1H)-one hydrochloride

TABLE 7
Formulations and characterization

| | | | Test (low sugar |
|---|---|---|---|
| | Target | Control | with lactase |
| | (full sugar) | (low sugar) | enzyme and |
| INGREDIENTS | (wt %) | (wt %) | flavor) (wt %) |
| Dairy powders blend | 13 | 15 | 15 |
| Sugar | 47 | 43 | 43 |
| Bulking agent | 1.60 | 2.20 | 2.20 |
| Palm Oil | 12.20 | 12.50 | 12.50 |
| Lactase enzyme | — | — | 0.12 |
| Flavor TasteGEM SG | — | — | 0.022 |
| Water | Up to 100 | Up to 100 | Up to 100 |
| Total | 100.00 | 100.00 | 100.00 |
| CHARACTERIZATION | | | |
| Water activity (1) | 0.830-0.840 | 0.850-0.860 | 0.830-0.840 |
| Sweetness (2) | 3.25 A | 2.70 B | 3.50 A |
| Mouthcoating (2) | 1.50 B | 1.38 B | 1.94 A |

(1) Values measured with water activity analyzer (AquaLab Pre)
(2) Values with same letter are not significantly different Student's t test significant differences at 90%, * 95%, ** 99%, *** 99.9% level of confidence.

1. A dairy composition, which comprises lactose hydrolysis products, glucosylated natural steviol glycosides, and a fruit juice concentrate.

2. The dairy composition of claim 1, wherein the lactose hydrolysis products comprise glucose and galactose.

3. The dairy composition of claim 1, further comprising unhydrolyzed lactose.

4. The dairy composition of claim 3, wherein the weight-to-weight ratio of lactose hydrolysis products to unhydrolyzed lactose ranges from 2:1 to 100:1.

5. The dairy composition of claim 1, wherein the concentration of glucosylated natural steviol glycosides in the dairy composition ranges from a sucrose equivalence of 1° Bx to a sucrose equivalence of 10° Bx.

6. The dairy composition of claim 1, further comprising sucrose, fructose, or a combination thereof.

7. The dairy composition of claim 1, further comprising sucralose, rebaudioside A, or a combination thereof.

8. The dairy composition of claim 1, wherein the fruit juice concentrate is a grape juice concentrate.

9. The dairy composition of claim 1, wherein the fruit juice concentrate is present in the dairy composition at a concentration ranging from 1 weight percent to 15 weight percent, based on the total weight of the dairy composition.
